(19) United States
(12) Patent Application Publication
(10) Pub. No.: US 2025/0050926 A1
(43) Pub. Date: Feb. 13, 2025

(54) FOLDABLE PUSHCART WITH MULTI-SECTION ADJUSTABLE BACKREST

(71) Applicant: IMAMI TOYS HEBEI CO., LTD., Handan City Hebei Province (CN)

(72) Inventor: Shuyong LUO, Handan City Hebei Province (CN)

(21) Appl. No.: 18/796,874

(22) Filed: Aug. 7, 2024

(30) Foreign Application Priority Data
Aug. 11, 2023 (CN) 202322164116.6

(51) Int. Cl. B62B 3/02; B62B 5/08

(52) U.S. Cl. CPC B62B 3/02; B62B 5/08

(57) ABSTRACT

A foldable pushcart with a multi-section adjustable backrest comprising, a foldable frame, wheels fixedly arranged below the frame, and a vehicle body fixedly arranged on the frame; wherein, the vehicle body comprises side walls, backrests and seat pads integrated; the backrest comprises a first backrest and a second backrest arranged symmetrically; the seat pad comprises a first seat pad connected with the first backrest and a second seat pad connected with the second backrest; a movable pad connected with the first seat pad is arranged between the first seat pad and the second seat pad; an accommodating cavity is provided below the movable pad; a rotatable support rod is symmetrically arranged on the frame; both ends of the support rod are rotatably connected with the base seat; a backrest is sleeved on the support rod; and the backrest is provided thereon with a height adjusting unit.

### CROSS-REFERENCE TO RELATED APPLICATIONS

This application claims priority pursuant to 35 U.S.C. 119(a) to Chinese Application No. 202322164116.6, filed Aug. 11, 2023, which application is incorporated herein by reference in its entirety.

### TECHNICAL FIELD

The present utility model relates to a field of pushcarts, and specifically, to a foldable pushcart with a multi-section adjustable backrest.

### BACKGROUND

With improvement of living standards, people have more and more opportunities to travel or camp, and also have a long time in staying outdoors with more daily necessities, work appliance and food to be carried. Foldable pushcarts that may be placed in a trunk to meet various needs of users are highly popular.

At present, all hand carts have the function of transporting goods, but are usually left unused once the goods are transported to a designated location, so it is necessary to improve structures, increase functionality, and achieve an effect of maximizing the use thereof.

### SUMMARY

The technical problem to be solved by the present utility model is to provide a foldable pushcart with a multi-section adjustable backrest, which not only has a function of carrying goods, but also provides users with a comfortable riding tool and a sleeping bed for lying down on and resting during a camping process, thereby meeting various needs of the users.

To solve the above-described technical problem, the technical solution adopted by the present utility model is as follows:

The pushcart of the present utility model includes a foldable frame, wheels fixedly arranged below the frame, and a vehicle body fixedly arranged on the frame; the vehicle body includes side walls, backrests and seat pads integrated; the backrest includes a first backrest and a second backrest arranged symmetrically; the seat pad includes a first seat pad connected with the first backrest and a second seat pad connected with the second backrest; a movable pad connected with the first seat pad is arranged between the first seat pad and the second seat pad; an accommodating cavity is provided below the movable pad; a rotatable support rod is symmetrically arranged on the frame; both ends of the support rod are rotatably connected with the base seat; a backrest is sleeved on the support rod; and the backrest is provided thereon with a height adjusting unit.

Further, the height adjusting unit includes two connecting ropes and a buckle for clamping the connecting ropes; one end of the connecting rope is fixed on a vertical rod, and the other end is connected with the buckle through a channel on the backrest.

Further, the buckle includes, on the rotating shaft (11-2), a fixed end and a movable end matched mutually, and a spring integrally arranged; the movable end is located inside the fixed end; and the spring is clamped between the movable end and the fixed end; the spring are fixed at both endpoints to the fixed end; the movable end is provided thereon with sawteeth; and the fixed end is provided thereon with grooves corresponding to the sawteeth.

Further, the frame includes a vertical rod fixedly arranged between the base seat and a top seat, as well as a side plate and a bottom plate arranged between the vertical rods; the side wall is fixed on the side plate; the seat pad is fixed on the bottom plate; a bottom end of the side plate is rotatably connected with the base seat; a top end of the side plate is rotatably connected with the top seat; and all the four endpoints of the bottom plate are rotatably connected with the base seat.

Further, the side plate includes two armrest rods symmetrically arranged and connected with the top seat, a first connecting rod arranged between the two armrest rods, and a second connecting rod connected with the bottom plate; a connecting bar is provided between the first connecting rod and the second connecting rod; the connecting bar is provided thereon with a third connecting rod; and two ends of the third connecting rod are connected with the armrest rod through a diagonal rod.

Further, the bottom plate includes two straight rods arranged symmetrically and connected with the base seat, a horizontal rod arranged between the straight rods, and a second connecting rod rotatably connecting the two straight rods; the horizontal rod is fixedly provided thereon with the seat pad; a connecting unit rotatably connected with the horizontal rod is provided between the horizontal rods on both sides; and an accommodating cavity is provided between the connecting unit and the horizontal rod.

Further, a step rod is provided below the accommodating cavity; and both ends of the step rod are connected with the second connecting rod.

Further, the connecting unit includes a short rod connected with the horizontal rod and a fourth connecting rod with both ends rotatably connected with the short rod.

Further, the top portion of the vertical rod is rotatably arranged with a push handle.

Further, the vertical rod is movably provided therein with a canopy support rod.

Due to the adoption of the above-described technical solutions, the present utility model could achieve advantageous effects as follows:

In the present utility model, the front plate and the rear plate of the prior art foldable cart are designed as backrests with adjustable height, and both backrests may be adjusted from 0° to 90°, thereby meeting various needs of users. When the backrest is arranged perpendicular to the bottom plate and the movable pad is arranged above the accommodating cavity, the cart may be used as a camping vehicle for transporting goods; when the movable pad is arranged on the first seat pad, it allows the user to sit thereon with feet comfortably placed in the accommodating cavity. When the backrest and the bottom plate are in a same plane, the cart may be used as a bed for users to lie down on and rest during camping; and the backrest may also be adjusted to an appropriate height according to actual needs to meet needs of users.

After use, the pushcart may be folded and stored in the trunk, so the pushcart is easy to carry, and has multiple functions, high practicality, a wide range of applications, and good comfort, thus it is highly favored by users.

### BRIEF DESCRIPTION OF DRAWINGS

Various embodiments are disclosed, by way of example only, with reference to the accompanying drawings in which corresponding reference symbols indicate corresponding parts, in which:

FIG. 1 is a schematic diagram of a three-dimensional structure of the pushcart according to the present utility model;

FIG. 2 is a structurally schematic front diagram of the frame of the pushcart according to the present utility model;

FIG. 3 is a structurally schematic diagram of the bottom plate of the pushcart according to the present utility model;

FIG. 4 is a structurally schematic diagram of the backrest in a tilt state of the pushcart according to the present utility model;

FIG. 5 is a structurally schematic diagram of the pushcart according to the present utility model, in which the backrest of the pushcart is in a state where the user can recline;

FIG. 6 is a structurally schematic diagram of the pushcart according to the present utility model, in which the backrest of the pushcart is in a state where the user can lie flat; and

FIG. 7 is a schematic rear diagram of a three-dimensional structure of the buckle of the pushcart according to the present utility model.

### DETAILED DESCRIPTION

The present utility model will be further illustrated in detail below in conjunction with embodiments.

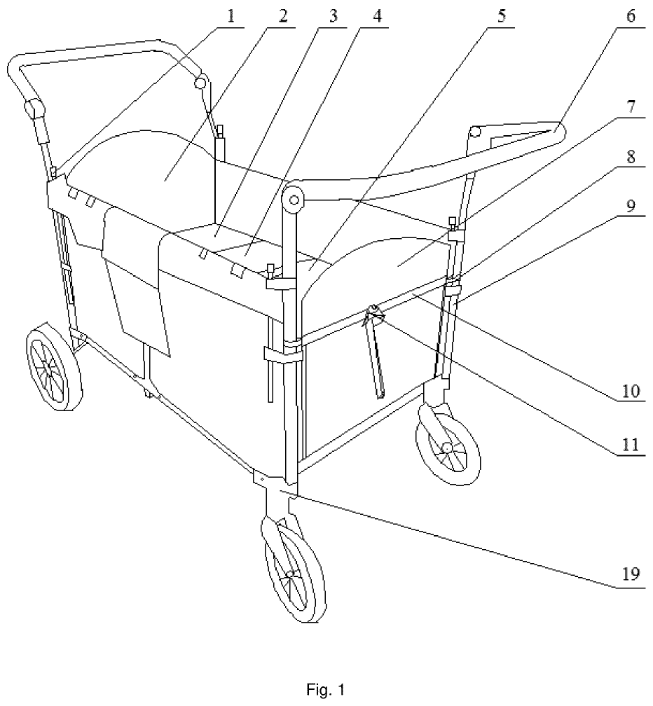

A foldable pushcart with a multi-section adjustable backrest, as shown in FIG. 1 to FIG. 7, includes a foldable frame, wheels fixedly arranged below the frame, and a vehicle body fixedly arranged on the frame; and the wheels roll on the ground to drive the frame and the vehicle body to move, thereby implementing a variety of functions.

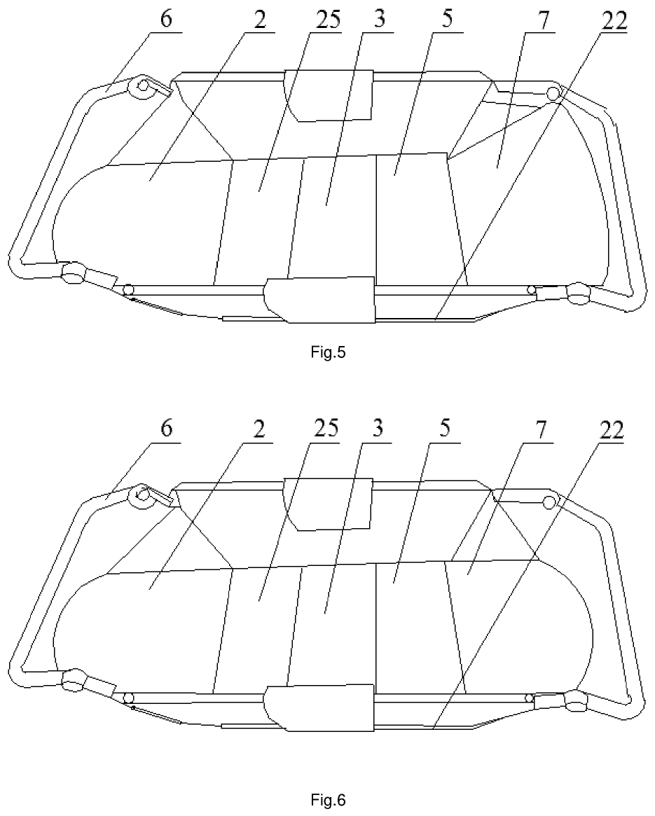

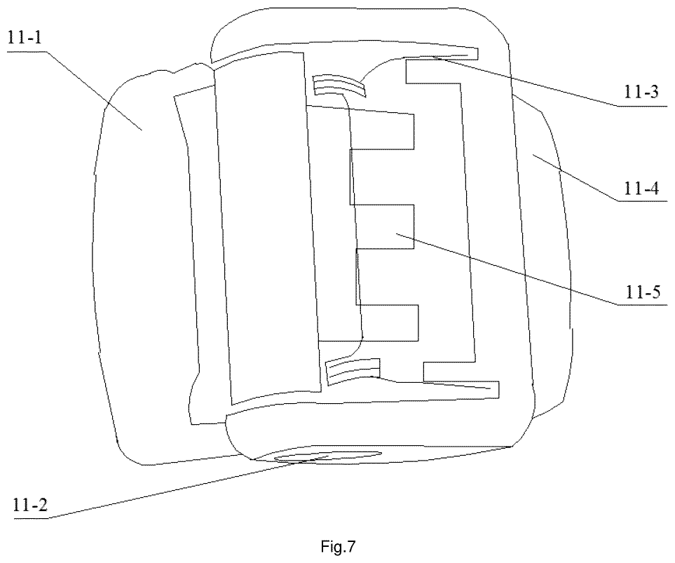

The vehicle body includes a side wall, a backrest and a seat pad integrally arranged; the backrest includes a first backrest 2 and a second backrest 7 arranged symmetrically; the seat pad includes a first seat pad 25 connected with the first backrest 2 and a second seat pad 5 connected with the second backrest 7; a movable pad 3 connected with the first seat pad 25 is arranged between the first seat pad 25 and the second seat pad 5; an accommodating cavity 4 is provided below the movable pad 3; when users sit on the first seat pad 25 or the second seat pad 5, the movable pad 3 may be lifted up and placed on the first seat pad 25, as shown in FIG. 1 and FIG. 4, at this time, according to the user's needs, the backrest may be adjusted to a state perpendicular to the ground, as shown in FIG. 1, or it may be adjusted to a tilt state as shown in FIG. 4; in this way, both the movable pad 3 and the second seat pad 5 may be used for sitting thereon at a same time with feet comfortably placed in the accommodating cavity; as shown in FIG. 5, when the user needs to half lie or recline thereon, the backrest on one side may be adjusted to a tilt state and the backrest on the other side to be parallel to the ground, at this time, the movable pad 3 should be placed above the accommodating cavity 4; as shown in FIG. 6, the backrests on both sides may also be adjusted to be parallel to the ground to meet the user's needs for lying flat.

In short, when the backrest is arranged vertically, the carriage enclosed by both backrests, the side walls, and the bottom plate may hold the transported goods, or may also be used as a crib for a baby to sleep safely therein, or may also be used as a stroller for the child to sit comfortably therein; after the transportation of the goods is completed, the height of the backrest may also be adjusted during camping and rest, so that the cart may be used as a lounge chair and a bed for a user. The pushcart has diverse uses, is convenient and practical, safe and reliable, and has different functions for choice at different stages, thereby truly maximizing the use thereof.

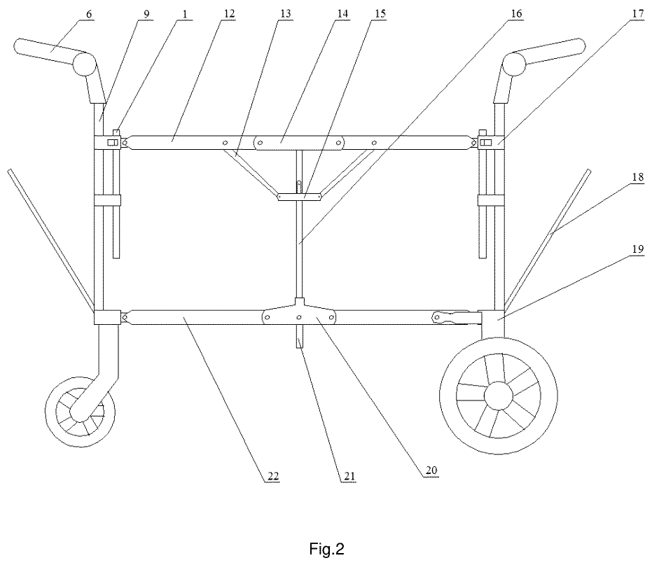

As shown in FIG. 2, the frame is symmetrically provided thereon with a rotatable support rod 18; both ends of the support rod 18 are rotatably connected with the base seat 19; the support rod 18 is sleeved thereon with a backrest; the backrest height may be adjusted by rotating the support rod 18 up and down; and a height adjusting unit is provided on the backrest in order to adjust the backrest height as needed.

As shown in FIG. 1, the height adjusting unit includes two connecting ropes 8 and a buckle 11 clamped on the connecting ropes 8; one end of the connecting rope 8 is fixed on the vertical rod 9, and the other end is connected with the buckle 11 through a channel 10 on the backrest; two connecting ropes 8 respectively pass through the channel 10 on both sides and are fixed together through the buckle 11. The buckle 11 plays a role in relaxing and tightening the connecting rope 8. On the one hand, the buckle 11 allows free adjustment of the length of the connecting ropes 8 on both sides, so as to achieve the adjustment of the backrest height; on the other hand, when the connecting rope 8 is adjusted to an appropriate length and the backrest is adjusted to an appropriate height, the buckle 11 is released so as to tighten the connecting ropes 8 on both sides, so that the adjusted backrest height remains unchanged without operating the buckle 11. It can be seen that when the backrest height needs to be adjusted, the buckle 11 may be operated to adjust the lengths of the connecting ropes 8 on both sides at will, so as to achieve the adjustment of the backrest height.

As shown in FIG. 7, the buckle 11 includes, on the rotating shaft 11-2, a fixed end 11-1 and a movable end 11-4 matched mutually, and a spring 11-3 integrally arranged; the movable end 11-4 is located within the fixed end 11-1; the spring 11-3 is clamped between the movable end 11-4 and the fixed end 11-1; the spring 11-3 are fixed at both endpoints to the fixed end 11-1; the movable end 11-4 is provided with sawteeth 11-5; and the fixed end 11-1 is provided thereon with a groove corresponding to the sawteeth 11-5. The corresponding arrangement of the sawteeth 11-5 and the groove may tighten the connecting rope 8 between the sawteeth 11-5 and the groove; when adjusting the backrest height, the movable end 11-4 may be operated to approach to the fixed end 11-1, thus the connecting rope 8 between the sawteeth 11-5 and the groove is loosen, so that the length of the connecting rope 8 may be adjusted as needed; when the connecting rope 8 is adjusted to an appropriate length, the operation of the movable end 11-4 is stopped; and under an elastic recovery force of the spring 11-3, the sawteeth 11-5 and the groove are restored to original positions thereof; meanwhile, the connecting rope 8 between the sawteeth 11-5 and the groove is tightened by the buckle 11 to complete the adjustment of the backrest height. When the backrest needs to be moved upwards, it may be done by simply shortening the distance of the connecting rope 8 between the vertical rod 9 and the buckle 11. When the backrest needs to be moved downwards, it may be done by simply lengthening the distance of the connecting rope 8 between the vertical rod 9 and the buckle 11.

As shown in FIG. 2, the frame includes a vertical rod 9 fixedly arranged between the base seat 19 and the top seat 17, and a side plate and a bottom plate arranged between the vertical rods 9; the side wall is fixedly arranged on the side plate; the seat pad is fixedly arranged on the bottom plate; the bottom end of the side plate is rotatably connected with the base seat 19; the top end of the side plate is rotatably connected with the top seat 17; and all the four endpoints of the bottom plate are rotatably connected with the base seat 19. When the pushcart being folded, the bottom plates, the side plates, and the backrests on both sides are retracted towards the middle simultaneously. When the pushcart being unfolded, the bottom plates, the side plates, and the backrests on both sides are unfolded outward simultaneously.

As shown in FIG. 2, the side plate includes an armrest rod 12 symmetrically arranged and connected with the top seat 17, a first connecting rod 14 arranged between two armrest rods 12, and a second connecting rod 20 connected with the bottom plate. A connecting bar 16 is provided between the first connecting rod 14 and the second connecting rod 20. That is to say, the side plates on both sides of the connecting bar 16 are symmetrically arranged. When the pushcart being folded, the first connecting rod 14 is lifted up, and the armrest rods 12 on both sides drive the vertical rod 9 connected therewith to move to the middle to implement folding; when the pushcart being used, the first connecting rod 14 is pressed down and meanwhile, the vertical rod 9 is pulled outward until the pushcart is fully unfolded.

The connecting bar 16 is provided thereon with a third connecting rod 15; both ends of the third connecting rod 15 are connected with the armrest rod 12 through a diagonal rod 13; and the diagonal rod 13 plays a role of effectively supporting the armrest rod 12. During the folding process of the pushcart, the diagonal rod 13 moves upwards and inwards with the armrest rod 12; when the pushcart being unfolded, the diagonal rod 13 moves outwards and downwards with the vertical rods 9 on both sides.

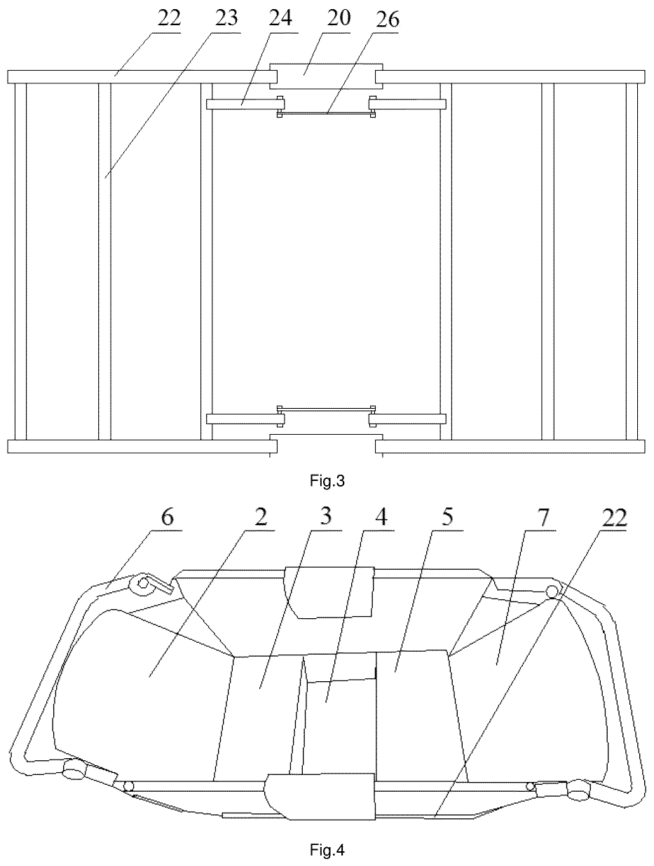

As shown in FIG. 3, the bottom plate includes two straight rods 22 symmetrically arranged and connected with the base seat 19, a horizontal rod 23 arranged between the straight rods 22, and a second connecting rod 20 rotatably connecting the two straight rods 22; and the horizontal rod 23 is fixedly provided thereon with a seat pad. During the folding process of the pushcart, the second connecting rod 20 moves upwards with the connecting bar 16; the straight rod 22 and the horizontal rod 23 drive the seat pad to move inwards simultaneously to implement folding; conversely, during the unfolding process of the pushcart, the straight rod 22 and the horizontal rod 23 drive the seat pad to move outwards to implement unfolding.

A connecting unit rotatably connected with the horizontal rod 23 is arranged between the horizontal rods 23 on both sides; the bottom plate may be folded and unfolded through the connecting unit; and the connecting unit includes a short rod 24 connected with the horizontal rod 23 and a fourth connecting rod 26 with both ends rotatably connected with the short rod 24. As the connecting bar 16 is lifted upwards, the second connecting rod 20 moves upwards accordingly; meanwhile, the connecting unit moves upwards, and the armrest rods 12 and the bottom plate on both sides are folded inwards to smoothly implement folding; when the pushcart being unfolded, the first connecting rod 14 is pressed down and the vertical rods 9 on both sides are pulled outwards and upwards, and the armrest rods 12 and the bottom plate on both sides move outwards and downwards accordingly to smoothly implement unfolding.

An accommodating cavity 4 is arranged between the connecting unit and the horizontal rod 23; a step rod 21 is provided below the accommodating cavity 4; both ends of the step rod 21 are connected with the second connecting rod 20. The step rod 21 plays a role in supporting the accommodating cavity 4, which allows the child to sit on the seat pad with feet comfortably placed in the accommodating cavity.

A top portion of the vertical rod 9 is rotatably provided with a push handle 6; and the push handle 6 may be adjusted to a suitable height for the convenience of pushing. The vertical rod 9 is movably provided therein with a canopy support rod 1; a canopy may be provided on the canopy support rod 1 as needed, and may be adjusted to a suitable height.

In summary, it can be known that the pushcart is foldable, and has multiple functions, which is suitable for various occasions and necessary for promotion.

Finally, it should be noted that the above-described embodiments are only examples provided to clearly illustrate the present utility model, and are not intended to limit it. Those ordinarily skilled in the art may make other different changes or modifications on the basis of the above-described illustrations; therefore, it is not possible to exhaustively list all the embodiments, and obvious changes or modifications arising therefrom still fall within the scope of the present utility model.

### REFERENCE NUMBERS

1 Canopy support rod
2 First backrest
3 Movable pad
4 Accommodating cavity
5 Second seat pad
6 Push handle
7 Second backrest
8 Connecting rope
9 Vertical rod
10 Channel
11 Buckle
11-1 Fixed end
11-2 Rotating shaft
11-3 Spring
11-4 Movable end
11-5 Sawteeth
12 Armrest rod
13 Diagonal rod
14 First connecting rod
15 Third connecting rod
16 Connecting bar
17 Top seat
18 Support rod
19 Base seat
20 Second connecting rod
21 Step rod
22 Straight rod
23 Horizontal rod
24 Short rod
25 First seat pad
26 Fourth connecting rod

What is claimed is:

1. A foldable pushcart with a multi-section adjustable backrest, comprising a foldable frame, wheels fixedly arranged below the frame, and a vehicle body fixedly arranged on the frame; wherein, the vehicle body comprises side walls, backrests and seat pads integrated; the backrest comprises a first backrest and a second backrest arranged symmetrically; the seat pad comprises a first seat pad connected with the first backrest and a second seat pad connected with the second backrest; a movable pad connected with the first seat pad is arranged between the first seat pad and the second seat pad; an accommodating cavity is provided below the movable pad; a rotatable support rod is symmetrically arranged on the frame; both ends of the support rod are rotatably connected with the base seat; a backrest is sleeved on the support rod; and the backrest is provided thereon with a height adjusting unit.

2. The foldable pushcart with the multi-section adjustable backrest according to claim 1, wherein, the height adjusting unit comprises two connecting ropes and a buckle for clamping the connecting ropes; one end of the connecting rope is fixed on a vertical rod, and the other end is connected with the buckle through a channel on the backrest.

3. The foldable pushcart with the multi-section adjustable backrest according to claim 2, wherein, the buckle comprises, on the rotating shaft, a fixed end and a movable end matched mutually and a spring integrally arranged; the movable end is located inside the fixed end; the spring is clamped between the movable end and the fixed end; the spring are fixed at both endpoints to the fixed end; the movable end is provided thereon with sawteeth; and the fixed end is provided thereon with grooves corresponding to the sawteeth.

4. The foldable pushcart with the multi-section adjustable backrest according to claim 1, wherein, the frame comprises a vertical rod fixedly arranged between the base seat and a top seat, as well as a side plate and a bottom plate arranged between the vertical rods; the side wall is fixed on the side plate; the seat pad is fixed on the bottom plate; the bottom end of the side plate is rotatably connected with the base seat; the top end of the side plate is rotatably connected with the top seat; and all the four endpoints of the bottom plate are rotatably connected with the base seat.

5. The foldable pushcart with the multi-section adjustable backrest according to claim 4, wherein, the side plate comprises two armrest rods symmetrically arranged and connected with the top seat, a first connecting rod arranged between the two armrest rods, and a second connecting rod connected with the bottom plate; a connecting bar is provided between the first connecting rod and the second connecting rod; the connecting bar is provided thereon with a third connecting rod; and both ends of the third connecting rod are connected with the armrest rod through a diagonal rod.

6. The foldable pushcart with the multi-section adjustable backrest according to claim 4, wherein, the bottom plate comprises two straight rods arranged symmetrically and connected with the base seat, a horizontal rod arranged between the straight rods, and a second connecting rod rotatably connecting the two straight rods; the horizontal rod is fixedly provided thereon with the seat pad; a connecting unit rotatably connected with the horizontal rod is provided between the horizontal rods on both sides; and an accommodating cavity is provided between the connecting unit and the horizontal rod.

7. The foldable pushcart with the multi-section adjustable backrest according to claim 6, wherein, a step rod is provided below the accommodating cavity; and both ends of the step rod are connected with the second connecting rod.

8. The foldable pushcart with the multi-section adjustable backrest according to claim 6, wherein, the connecting unit comprises a short rod connected with the horizontal rod and a fourth connecting rod with both ends rotatably connected with the short rod.

9. The foldable pushcart with the multi-section adjustable backrest according to claim 2, wherein, the top portion of the vertical rod is rotatably arranged with a push handle.

10. The foldable pushcart with the multi-section adjustable backrest according to claim 9, wherein, the vertical rod is movably provided therein with a canopy support rod.
